(19) United States
(12) Patent Application Publication
(10) Pub. No.: US 2025/0315344 A1
(43) Pub. Date: Oct. 9, 2025

(54) MULTIPLE BIT FLIP THRESHOLD SETS FOR IMPROVED ERROR CORRECTION IN A MEMORY SUB-SYSTEM

(71) Applicant: MICRON TECHNOLOGY, INC., Boise, ID (US)

(72) Inventors: Mariano Eduardo Burich, San Diego, CA (US); Mustafa N. Kaynak, San Diego, CA (US); Sivagnanam Parthasarathy, Carlsbad, CA (US); Eyal En Gad, Santa Clara, CA (US)

(21) Appl. No.: 19/088,010

(22) Filed: Mar. 24, 2025

Related U.S. Application Data
(60) Provisional application No. 63/573,569, filed on Apr. 3, 2024.

(51) Int. Cl. G06F 11/10

(52) U.S. Cl. CPC G06F 11/1068; G06F 11/1048

(57) ABSTRACT

A soft input is obtained from a sense word corresponding to encoded host data read from the memory device and decoded using a parity-check matrix. A match array is maintained. Each iteration of an error correcting code operation a number of unsatisfied check nodes of a respective bit of the sense word is calculated for each bit of the sense word. A bit flip threshold value from a threshold value data structure is obtained based on a current iteration of the error correcting code operation, a soft bit associated with the respective bit, and a match bit associated with the respective bit. The respective bit is flipped based on the number of unsatisfied check nodes satisfying the bit flip threshold value.

### RELATED APPLICATIONS

This application claims the benefit of U.S. Provisional Patent Application No. 63/573,569, filed Apr. 3, 2024, which is incorporated by reference herein.

### TECHNICAL FIELD

Embodiments of the disclosure relate generally to memory sub-systems, and more specifically, relate to multiple bit flip threshold sets for improved error correction in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1A illustrates an example computing system that includes a memory sub-system in accordance with some embodiments of the present disclosure.

FIG. 1B illustrates a block diagram of a memory device in communication with a memory sub-system in accordance with some embodiments of the present disclosure.

FIG. 2 illustrates a decoding component with multiple bit flip threshold sets for improved error correction, in accordance with some embodiments of the present disclosure.

FIG. 3 is a high-level flow diagram of an example method for error correcting code operations with multiple bit flip threshold sets for improved error correction, in accordance with some embodiments.

FIG. 4 is a high-level flow diagram of an example method for error correcting code operations with multiple bit flip threshold sets for improved error correction, in accordance with some embodiments.

FIG. 5 is a block diagram of an example computer system in which embodiments of the present disclosure may operate.

### DETAILED DESCRIPTION

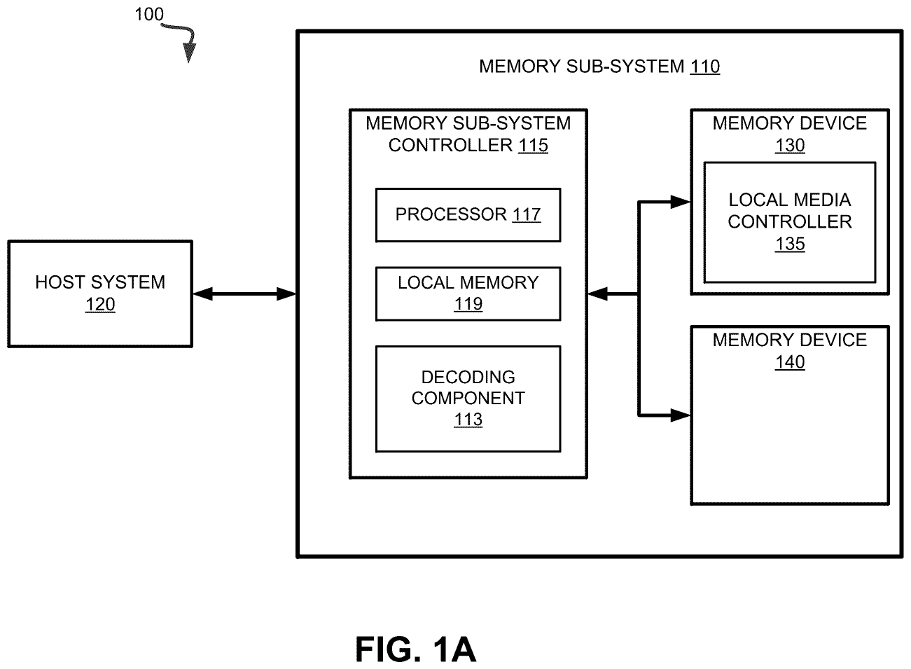

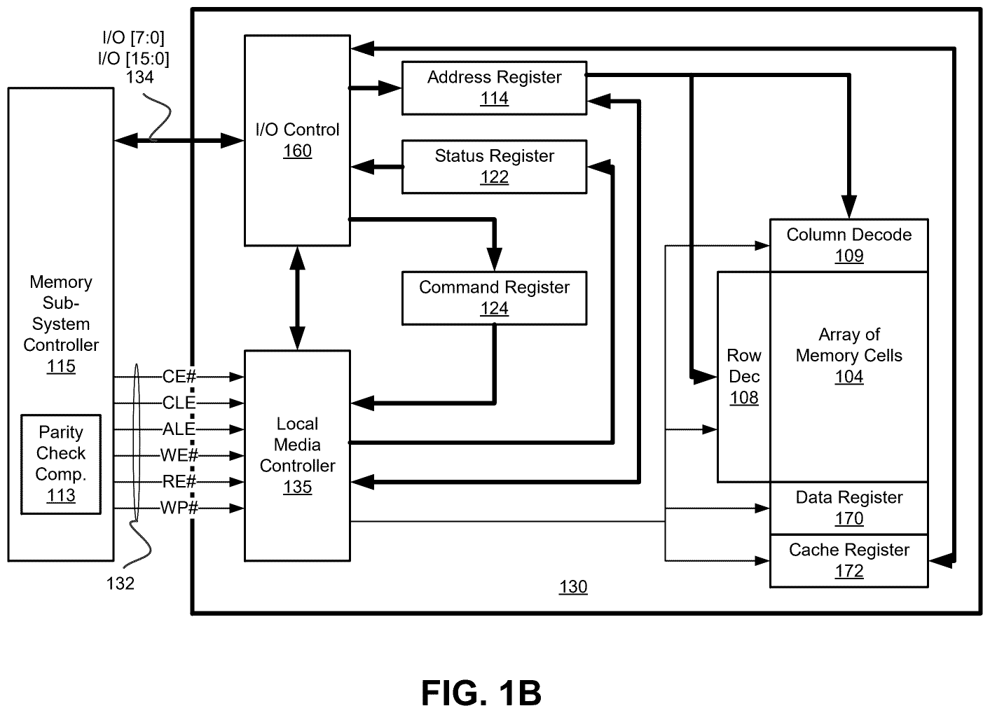

Aspects of the present disclosure are directed to error correcting code operations with multiple bit flip threshold sets for improved error correction in a memory sub-system. A memory sub-system can be a storage device, a memory module, or a combination of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1A. A non-volatile memory device is a package of one or more dies. Each die can include one or more planes. For some types of non-volatile memory devices (e.g., NAND memory devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include cells arranged in a two-dimensional or a three-dimensional grid. Memory cells can be formed onto a silicon wafer in an array of columns connected by conductive lines (also hereinafter referred to as bitlines, or BLs) and rows connected by conductive lines (also hereinafter referred to as wordlines or WLs). A wordline can refer to a conductive line that connects control gates of a set (e.g., one or more rows) of memory cells of a memory device that are used with one or more bitlines to generate the address of each of the memory cells. In some embodiments, each plane can carry an array of memory cells formed onto a silicon wafer and joined by conductive BLs and WLs, such that a wordline joins multiple memory cells forming a row of the array of memory cells, while a bitline joins multiple memory cells forming a column of the array of memory cells. The intersection of a bitline and wordline constitutes the address of the memory cell. A block hereinafter refers to a unit of the memory device used to store data and can include a group of memory cells, a wordline group, a wordline, or individual memory cells addressable by one or more wordlines. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types. For case of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

One example of a memory sub-system is a solid-state drive (SSD) that includes one or more non-volatile memory devices and a memory sub-system controller to manage the non-volatile memory devices. The memory sub-system controller can encode data into a format for storage at the memory device(s). For example, a class of error detection and correcting codes (ECC), such as low density parity check (LDPC) codes, can be used to encode the data. LDPC codes are capacity-approaching codes, which means that practical constructions exist which allow the error threshold to be set very close to a theoretical maximum. This error threshold defines an upper bound for errors in the data, up to which the probability of lost information can be made as small as desired. LDPC codes are reliable and highly efficient, making them useful in bandwidth-constrained applications. For example, encoded data written to physical memory cells of a memory device can be referred to as a codeword. The data read from the cells, which might include errors and differ from the codeword, can be referred to as a sense word. The sense word can include one or more of user data, error correcting code, metadata, or other information.

The memory sub-system controller can perform decoding operations to decode the encoded data into the original sequence of bits that were encoded for storage on the memory device. In many cases, the encoded data is decoded using an iterative process. Segments of a data array can be decoded to produce a corresponding string of bits (e.g., a sense word). A number of bits of the decoded data received by the memory sub-system controller may have been flipped (i.e., reversed) due to noise, interference, distortion, bit synchronization errors, or errors from the media itself (both intrinsic and extrinsic). For example, a bit that may have originally been stored as a 0 may be flipped to a 1 or vice versa. A memory sub-system may perform error correcting code operations to attempt to correct errors (e.g., flipped bits) in a sense word. For example, a memory sub-system can perform error correcting code operations on stored data to detect and correct errors in the encoded data.

Generally, error correction in a memory sub-system is time-and resource-intensive. Certain memory sub-systems utilize algorithms, such as bit-flipping algorithms, to identify and correct the errors. Bit-flipping algorithms iteratively correct errors in the received codeword until it becomes a valid codeword or until a predefined number of iterations is reached. More specifically, the bit-flipping algorithm starts with the sense word, which might have some bit errors.

For each iteration, the bit-flipping algorithm calculates a syndrome vector to determine whether the sense word contains errors. The syndrome vector is calculated by multiplying the sense word and a parity-check matrix. The parity-check matrix is a matrix used to verify whether a given word (a string of numbers) is a valid codeword (a transmitted word that conforms to the rules of the LDPC). If the syndrome vector equals zero, the sense word contains no errors, otherwise the sense word contains errors.

In response to the syndrome vector not equaling zero, certain memory sub-systems conditionally flip each bit. In particular, the bit-flipping algorithm identifies non-zero values within the syndrome vector. Non-zero values within the syndrome vector represent unsatisfied check nodes. A check node is a node of a graph (e.g., a Tanner graph used to represent LDPC), in which each node represents a parity-check equation. A check node is considered unsatisfied (e.g., unsatisfied check nodes) if the sum of its neighboring variable nodes does not satisfy the corresponding parity-check equation (often a modulo-2 sum for binary codes). Variable nodes correspond to bits in the sense word.

The bit-flipping algorithm determines whether to flip a bit by comparing the number of unsatisfied check nodes with a threshold value. The threshold value serves as a criterion for making the decision to flip a bit. The threshold value may be a predetermined value, or a value based on statistical models, simulations, or other heuristics. In some conventional memory sub-systems, the threshold value may be a threshold value of multiple threshold values assigned to a respective iteration of the predefined number of iterations. In other words, based on statistical models, simulations, or other heuristics, each iteration of the bit-flipping algorithm is assigned a threshold value. Accordingly, the bit-flipping algorithm solely flips the bit in a respective iteration if the number of unsatisfied check nodes exceeds the threshold value for the respective iteration. The bit-flipping algorithm iteratively updates the syndrome vector as the bits are flipped, checks for successful decoding, and flips bits until decoding is successful or a maximum number of iterations is reached.

In some conventional memory sub-systems, depending on specific requirements and constraints, the bit-flipping algorithm may utilize a single set of flip bit thresholds during the bit-flipping algorithm. While, the single set of bit flip thresholds may be efficient, they are not suitable for sense words that may have been impacted by different noise, disturb, and/or error mechanism. Additionally, due to the intrinsic variability of the memory sub-system, the single set of flip bit thresholds may fail to account for the various instances of the varying memory sub-system.

Aspects of the present disclosure address the above and other deficiencies by performing error correcting code operations with multiple bit flip threshold sets for improved error correction in a memory sub-system. In particular, each set of consecutive iterations of the error correcting code operation (e.g., bit flipping algorithms) is assigned a set of threshold values. An initial set of consecutive iterations of the error correcting code operation may be assigned a set of threshold values. A set of consecutive iterations of the error correcting code operation subsequent to the initial set of consecutive iterations of the error correcting code operation may be assigned another set of threshold values. Each subsequent set of consecutive iterations of the error correcting code operation, thereafter, is assigned a unique set of threshold values that is optimized based on the previous set of threshold values. Thus, each set of consecutive iterations of the error correcting code operation can more accurately correct errors as compared to a previous set of consecutive iterations of the error correcting code operations thereby compensating for unique scenarios.

Advantages of the present disclosure include, but are not limited to, increasing accuracy and performance in correcting errors across a wider range of scenarios, including more unique scenarios which increases the decoding efficiency of the memory sub-system, thereby increasing reliability, performance, and longevity of the memory sub-system.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus).

The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115, for example, may employ a Flash Translation Layer (FTL) to translate logical addresses to corresponding physical memory addresses, which can be stored in one or more FTL mapping tables. In some instances, the FTL mapping table can be referred to as a logical-to-physical (L2P) mapping table storing L2P mapping information. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

In at least one embodiment, memory sub-system 110 may include a decoding component 113 that performs error correcting code operations using multiple bit flip threshold sets for improved error correction. In some embodiments, the memory sub-system controller 115 includes at least a portion of the decoding component 113. In some embodiments, the decoding component 113 is part of the host system 120, an application, or an operating system. In other embodiments, local media controller 135 includes at least a portion of decoding component 113 and is configured to perform the functionality described herein.

Decoding component 113 can receive an encoded data (e.g., host data encoded using a predefined matrix, such as a parity-check matrix) read from memory device 130 and/or 140 which might contain some bit errors. Decoding component 113 performs a decoding operation to decode the encoded data using an iterative process. Segments of a data array can be decoded to produce a corresponding string of bits (e.g., a sense word).

Decoding component 113 may iteratively perform error correcting code operations to correct errors in the sense word until it becomes valid or a plurality of iterations of the error correcting code operation is performed. The plurality of iterations may be a predefined number of iterations. More specifically, decoding component 113 may divide the plurality of iterations into a plurality of subsets of the plurality of iteration and perform error correcting code operations for each subset of the plurality of subsets to correct errors in the sense word until it becomes valid or until the plurality of subsets is performed. Each subset of the plurality of subsets is defined by a set of sequential iterations from the plurality of iterations. Depending on the embodiment, the plurality of iterations of the error correcting code operation may be divided evenly, or unevenly among the plurality of subsets.

Each subset of the plurality of subsets is assigned a set of bit flip threshold values stored in from a threshold set table. The threshold set table includes a plurality of rows. Each row of the plurality of rows corresponds to a subset of the plurality of subsets and stores the corresponding set of bit flip threshold values. The set of bit flip threshold values includes a bit flip threshold value for each iteration of the subset that is used to determine whether to flip a bit of the sense word (e.g., based on a number of unsatisfied check nodes associated with the bit exceeding a respective bit flip threshold value) or not (e.g., based on the number of unsatisfied check nodes associated with the bit not exceeding the respective bit flip threshold value). The threshold set table may be stored in the local memory 119 of the memory sub-system controller 115. Each set of bit flip threshold values may be optimized for a metric (e.g., faster convergence, higher error correction, lower energy usage, or any other suitable metric of memory sub-system) using statistical models, simulations, or other heuristics, to achieve a desired metric.

In an exemplary approach, a first set of bit flip threshold values may be optimized for a first metric and a second set of bit flip threshold values may be optimized for a second metric. The first set of bit flip threshold values and the second set of bit flip threshold values may be individually and/or jointly optimized using statistical models, simulations, or other heuristics so as to not interfere with the capabilities of one another. A third set of bit flip threshold values may be optimized to for a third metric. However, the third set of bit flip threshold values may be optimized using the first and/or the second set of bit flip threshold values. This approach provides the ability for the third set of bit flip threshold values be further optimized to correct data that is unable to be corrected using the first and/or the second set of bit flip threshold values. Each subsequent set of bit flip threshold values (e.g., a fourth set of bit flip threshold values, a fifth set of bit flip threshold values) is based on a previous set of bit flip threshold values (e.g., the third set of bit flip threshold values, the fourth set of bit flip threshold values, the fifth set of bit flip threshold values, respectively). While, it is described that a subsequent set of bit flip threshold values is further optimized based on a previous set of bit flip threshold values, it is also considered that a subsequent set of bit flip threshold values is further optimized based on a previous set of bit flip threshold values which is optimized for a specific metric.

Prior to performing error correction code operations of the decoding component 113 for a respective subset of the plurality subset, decoding component 113 retrieves, from the threshold set table, a corresponding set of bit flip threshold values. At the beginning of each iteration of the respective subset, decoding component 113, as noted above, calculates, based on the predefined matrix and the sense word, a syndrome vector to determine whether the sense word contains errors. The syndrome vector is calculated by multiplying the sense word and a parity-check matrix. If the syndrome vector does not equal zero (e.g., 0), decoding component 113 determines that the sense word contains errors. As a result, the decoding component 113 performs an error correcting code operation to correct errors in the sense word. Otherwise, decoding component 113 determines that the sense word contains no errors and was successfully decoded.

Error correcting code operation of decoding component 113, for each bit of the sense word, obtains a number of unsatisfied check nodes for a respective bit. As previously described, unsatisfied check nodes refer to the non-zero values within the syndrome vector. A check node is associated with each row of the parity-check matrix. A check node is considered unsatisfied (e.g., unsatisfied check nodes) if the sum of its neighboring variable nodes does not satisfy the corresponding parity-check equation (often a modulo-2 sum for binary codes). Variable nodes correspond to bits in the sense word. Accordingly, to obtain the number of unsatisfied check nodes for a respective bit, the number of check nodes that are not satisfied are counted.

Decoding component 113, based on the iteration of the respective subset, identifies a bit flip threshold value of the corresponding set of bit flip threshold values associated with the iteration of the respective subset (e.g., the identified bit flip threshold value). Error correcting code operation of the decoding component 113 determines whether the number of unsatisfied check nodes for the respective bit exceeds the identified bit flip threshold value. Responsive to the number of unsatisfied check nodes for the respective bit exceeding the identified bit flip threshold value, error correcting code operation of the decoding component 113 flips the respective bit.

After performing error correction code operations of the decoding component 113 for the respective subset of the plurality subset (i.e., completing an error correcting code operation for each iteration of the respective subset), decoding component 113 may determine whether the sense word contains errors using a syndrome vector. Responsive to determining that the sense word contains no errors, decoding component 113 determines that the sense word was successfully decoded and returns the sense word to the host system 120. Responsive to determining that the sense word contains errors, decoding component 113 determines whether the respective subset is a last subset of the plurality of subsets. Responsive to determining that the respective subset is the last subset of the plurality of subsets, decoding component 113 determines that the sense word still contains errors. In some embodiments, in response to the sense word still containing errors additional decoding strategies may be employed.

Responsive to determining that the respective subset is not the last subset of the plurality of subsets, decoding component 113 may undo the sense word (e.g., reset the sense word) modified by performing error correction code operations of the decoding component 113 for the respective subset. Decoding component 113, may proceed to performing error correction code operations of the decoding component 113 for a subsequent subset of the plurality subset to correct errors in the sense word.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. The memory sub-system controller 115, as noted above, includes the decoding component 113 (or decoding com. 113) that performs error correcting code operations using multiple bit flip threshold sets for improved error correction. Some examples of electronic systems include personal computers, personal digital assistants (PDAs), digital cameras, digital media players, digital recorders, games, appliances, vehicles, wireless devices, mobile telephones, and the like. The memory sub-system controller 115 (e.g., a controller external to the memory device 130), may be a memory controller or other external host device.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bit line). A single access line may be associated with more than one logical row of memory cells and a single data line may be associated with more than one logical column. Memory cells (not shown in FIG. 1B) of at least a portion of array of memory cells 104 are capable of being programmed to one of at least two target data states.

Row decode circuitry 108 and column decode circuitry 109 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 109 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 109 to control the row decode circuitry 108 and column decode circuitry 109 in response to the addresses.

The local media controller 135 is also in communication with a cache register 172. Cache register 172 latches data, either incoming or outgoing, as directed by the local media controller 135 to temporarily store data while the array of memory cells 104 is busy writing or reading, respectively, other data. During a program operation (e.g., write operation), data may be passed from the cache register 172 to the data register 170 for transfer to the array of memory cells 104; then new data may be latched in the cache register 172 from the I/O control circuitry 160. During a read operation, data may be passed from the cache register 172 to the I/O control circuitry 160 for output to the memory sub-system controller 115; then new data may be passed from the data register 170 to the cache register 172. The cache register 172 and/or the data register 170 may form (e.g., may form a portion of) a page buffer of the memory device 130. A page buffer may further include sensing devices (not shown in FIG. 1B) to sense a data state of a memory cell of the array of memory cells 104, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 236 and outputs data to the memory sub-system controller 115 over I/O bus 236.

For example, the commands may be received over input/output (I/O) pins [7:0] of I/O bus 236 at I/O control circuitry 160 and may then be written into command register 124. The addresses may be received over input/output (I/O) pins [7:0] of I/O bus 236 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 172. The data may be subsequently written into data register 170 for programming the array of memory cells 104.

In an embodiment, cache register 172 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

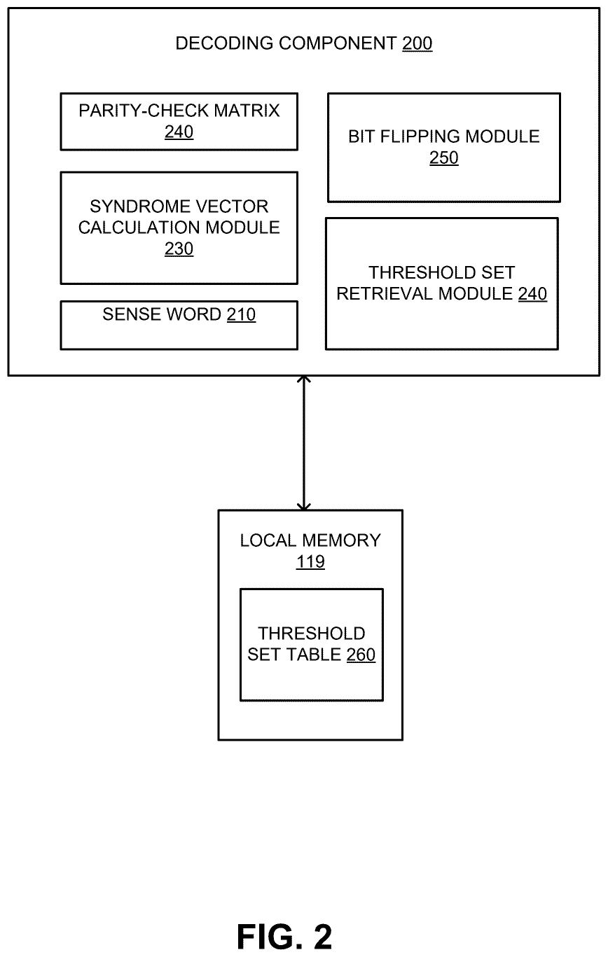

FIG. 2 illustrates a decoding component with multiple bit flip threshold sets for improved error correction, in accordance with some embodiments of the present disclosure. Decoding component 200, similar to decoding component 113 of FIG. 1A, includes a sense word 210, a parity-check matrix 220, a syndrome vector calculation module 230, a threshold set retrieval module 240, and a bit flipping module 250. Local memory, in an exemplary embodiment, includes a threshold set data structure (e.g., a threshold set table 260)

Decoding component 200 may receive encoded data which might contain some bit errors (e.g., host data encoded using parity-check matrix 220) read from a memory device. Decoding component 200 performs a decoding operation to decode the encoded data to produce sense word 210. Decoding component 200 may determine that sense word 210 contains errors. In particular, syndrome vector calculation module 230 utilizes sense word 210 and parity-check matrix 220 to calculate a syndrome vector. If the syndrome vector does not equal zero (‘0’), decoding component 200 determines that sense word 210 contains errors. Otherwise, decoding component 200 determines that sense word 210 contains no errors and was successfully decoded.

Responsive to determining that sense word 210 contains errors, decoding component 200 may iteratively perform error correcting code operations (via bit flipping module 250) for each subset of a plurality of subsets of a plurality of iteration to correct the errors in sense word 210. As previously described, the plurality of iterations is divided into the plurality of subsets of the plurality of iteration.

Bit flipping module 250, with each subset, may maintain a current subset of the plurality of subsets, and a current iteration of the current subset. Each subset of the plurality of subsets, threshold set retrieval module 240 retrieves, from the threshold set table 260 stored in local memory 119, a set of bit flip threshold values associated with a current subset of the plurality of subset. More specifically, threshold retrieval module 260 queries, using the current subset, the set of bit flip threshold values associated with a current subset of the plurality of subset. Threshold retrieval module 260 provides the set of bit flip threshold values to the bit flipping module 250.

Each iteration of the current subset, bit flipping module 250, for each bit of sense word 210, calculates a number of unsatisfied check nodes of a respective bit of sense word 210. Bit flipping module 250, based on a current iteration of the current subset, identifies a bit flip threshold value of the retrieved set of bit flip threshold values. Bit flipping module 250 determines whether the unsatisfied check nodes of the respective bit of sense word 210 satisfy the identified bit flip threshold value. In particular, bit flipping module 250 determines whether to flip a bit of sense word 210 (e.g., based on the number of unsatisfied check nodes exceeding the identified bit flip threshold value) or not (e.g., based on the number of unsatisfied check nodes not exceeding the identified bit flip threshold value). Responsive to determining that the bit should be flipped, bit flipping module 250 flips the bit of the sense word 210.

Responsive to completing each iteration of a current subset, decoding component 200, determines whether the current subset corrected the errors of sense word 210. In particular, syndrome vector calculation module 230 utilizes sense word 210 after the current subset and parity-check matrix 220 to calculate an updated syndrome vector of the sense word 210. If the updated syndrome vector does not equal zero (‘0’), decoding component 200 determines that sense word 210 contains errors. Otherwise, decoding component 200 determines that sense word 210 contains no errors and was successfully decoded.

Responsive to determining that sense word 210 contains errors based on the updated syndrome vector, decoding component 200 determines whether the current subset is a last subset of the plurality of subsets. Responsive to determining that the current subset is not the last subset of the plurality of subsets, decoding component 200 determines that the sense word still contains errors and was not successfully decoded and employs decoding strategies.

Responsive to determining that the respective subset is not the last subset of the plurality of subsets, decoding component 200 may reset sense word 210. Decoding component 200 proceeds to a subsequent subset of the plurality subset. In particular, bit flipping module proceeds to the next subset of the plurality subset after the current subset to correct errors in the sense word.

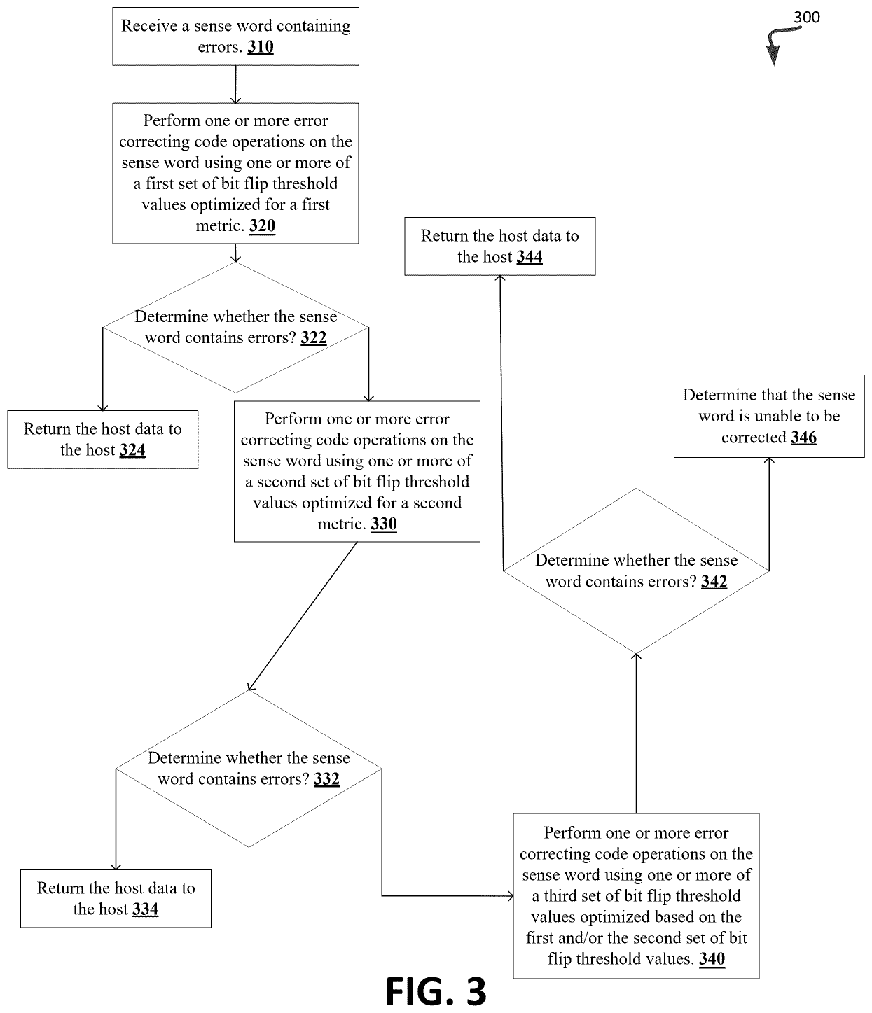

FIG. 3 is a flow diagram of an example method for error correcting code operations with multiple bit flip threshold sets for improved error correction in accordance with some embodiments of the present disclosure. Method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by decoding component 113 of FIG. 1A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing device receives sense word containing errors. As previously described, sense word is encoded data read from a physical memory cells of a memory device. The data read from the cells may be the encoded data including errors.

At operation 320, the processing device performs one or more error correcting code operations on the sense word using one or more of a first set of bit flip threshold values. The first set of bit flip threshold values corresponds to a subset of the one or more error correcting code operations. The first set of bit flip threshold values may be optimized for a first metric.

The error correcting code operations may have a plurality of iterations, which are predefined. The plurality of iterations may be divided into a plurality of subsets. Each subset is assigned a set of bit flip threshold values (e.g., a first set of bit flip threshold values). The set of bit flip threshold values includes a bit flip threshold value for each iteration of the subset that is used to determine whether to flip a bit of the sense word (e.g., based on a number of unsatisfied check nodes associated with the bit exceeding a respective bit flip threshold value) or not (e.g., based on the number of unsatisfied check nodes associated with the bit not exceeding the respective bit flip threshold value).

Accordingly, each of the one or more error correcting code operations (e.g., the subset corresponding to the first set of bit flip threshold values) is performed using a bit flip threshold value of the first set of bit flip threshold values. After performing each of the one or more error correcting code operations, the processing device determines whether the sense word contains errors. If the sense word contains errors, the processing device proceeds to a next error correcting code operation of the one or more error correcting code operations. Once each bit flip threshold value of the first set of bit flip threshold values is used to perform an error correcting code operations, the processing device indicates that the one or more error correcting code operations is completed.

Once operation 320 is complete, the processing logic proceeds to operations 322. At operation 322, the processing device determines whether the sense word contains errors. Responsive to determining that the sense word is corrected, the processing device proceeds to operations 324. At operation 324, the processing logic returns the host data to the host. Responsive to determining that the sense word is not corrected, the processing device resets the sense word to the original sense word read from the memory device and then proceeds to operation 330.

At operation 330, the processing device performs one or more error correcting code operations on the sense word using one or more of a second set of bit flip threshold values. As previously described and noted above, each of the one or more error correcting code operations (e.g., the subset corresponding to the second set of bit flip threshold values) is performed using a bit flip threshold value of the second set of bit flip threshold values. The second set of bit flip threshold values may be optimized for a second metric. Once operation 330 is complete, the processing logic proceeds to operations 332. At operation 332, the processing device determines whether the sense word contains errors. Responsive to determining that the sense word is corrected, the processing device proceeds to operations 334. At operation 334, the processing logic returns the host data to the host. Responsive to determining that the sense word is not corrected, the processing device resets the sense word to the original sense word read from the memory device and then proceeds to operation 340.

At operation 340, the processing device performs error correcting code operation on the sense word with each bit flip threshold value of a third set of bit flip threshold values. As previously described and noted above, each of the one or more error correcting code operations (e.g., the subset corresponding to the third set of bit flip threshold values) is performed using a bit flip threshold value of the second set of bit flip threshold values. The third set of bit flip threshold values may be optimized based on the first and/or the second set of bit flip threshold values. Accordingly, the third set of bit flip threshold values may be better in correcting the sense word containing errors than the second set of bit flip threshold values. Once operation 340 is complete, the processing logic proceeds to operations 342. At operation 342, the processing device determines whether the sense word contains errors. Responsive to determining that the sense word is corrected, the processing device proceeds to operations 344. At operation 344, the processing logic returns the host data to the host. Responsive to determining that the sense word is not corrected, the processing device proceeds to operations 346. At operation 346, the processing device determines that the sense word is unable to be corrected.

It is important to note that the present flow diagram provides an example with only three sets of bit flip threshold values (e.g., the first, second, and third set of bit flip threshold values) being used to attempt to correct the sense word. Thus, after the last set of bit flip threshold values (e.g., the third set of bit flip threshold values) is used, the processing device may determine that the sense word is unable to be corrected or employ additional decoding strategies. However, it is contemplated that the process may continue based on the number of sets of bit flip thresholds (e.g., N number of bit flip threshold values). Thus, each of the N number of bit flip threshold values are used to attempt to correct the sense word. Once the last set of the N number of bit flip threshold values is used, the processing device may determine that the sense word is unable to be corrected or employ additional decoding strategies. Depending on the embodiment, N number of bit flip threshold values may be predefined and chosen based on a balance between latency and correctability.

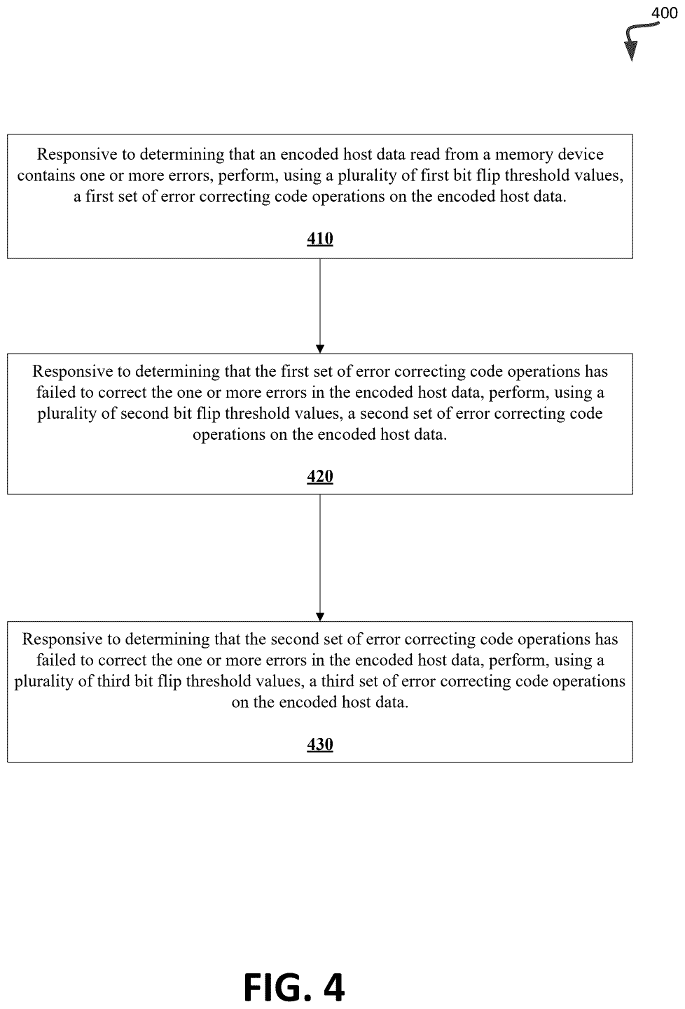

FIG. 4 is a flow diagram of an example method for error correcting code operations with multiple bit flip threshold sets for improved error correction in accordance with some embodiments of the present disclosure. Method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by decoding component 113 of FIG. 1A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, responsive to determining that an encoded host data read from a memory device contains one or more errors, the processing device performs, using a plurality of first bit flip threshold values, a first set of error correcting code operations on the encoded host data. The first set of bit flip threshold values, as previously described, may be optimized for a first metric.

As previously described, error correcting code operations is iteratively performed to correct errors in the encoded host data read from the memory device containing one or more errors (e.g., the sense word) until it becomes valid or a plurality of iterations of the error correcting code operation is performed. The plurality of iterations may be a predefined number of iterations. The plurality of iterations may be divided into a plurality of sets (e.g., a first set of error correcting code operations, a second set of error correcting code operations, and a third set of error correcting code operations). Each set of error correcting code operations includes a predetermined number of iterations of the plurality of iterations in which the error correcting code operations are performed.

Each set of error correcting code operations may be assigned a plurality of bit flip threshold values (e.g., a plurality of first bit flip threshold values, a plurality of second bit flip threshold values, and a plurality of third bit flip threshold values). Each plurality of bit flip threshold values (e.g., a plurality of first bit flip threshold values, a plurality of second bit flip threshold values, and a plurality of third bit flip threshold values) is stored in local memory and indexed by a corresponding set of error correcting code operations (e.g., a first set of error correcting code operations, a second set of error correcting code operations, and a third set of error correcting code operations, respectively).

For each iteration of the first set of error correcting code operations, the processing device obtains the first bit flip threshold value of the plurality of first bit flip threshold values associated with a respective iteration of the first set of error correcting code operations. As previously described, each first bit flip threshold value of the plurality of first bit flip threshold values corresponds to an iterations of the first set of error correcting code operations. The processing device determines, for each bit of the encoded host data, whether a number of unsatisfied check nodes connected to a respective bit satisfies the first bit flip threshold value of the plurality of first bit flip threshold values associated with the respective iteration. As previously described, obtaining the number of unsatisfied check nodes includes identifying a number of non-zero values within a syndrome vector of the sense word. Responsive to determining that the number of unsatisfied check nodes connected to the respective bit satisfies the first bit flip threshold value of the plurality of first bit flip threshold values associated with the respective iteration, the processing device flips the respective bit of the encoded host data.

Responsive to determining that the first set of error correcting code operations has successfully corrected the one or more errors in the encoded host data, processing device returns host data. In particular, if any iterations of the first set of error correcting code operations have successfully corrected the one or more errors in the encoded host data, processing device returns host data.

Prior to proceeding to operations 420 to perform a second set of error correcting code operations on the encoded host data the processing device, for each bit of the encoded host data changed, returns a respective bit of the encoded host data back to an original value of the respective bit. As previously described, the processing device may undo any modification to the sense word done as a result of performing the first set of error correcting code operations.

At operation 420, responsive to determining that the first set of error correcting code operations has failed to correct the one or more errors in the encoded host data, the processing device performs, using a plurality of second bit flip threshold values, a second set of error correcting code operations on the encoded host data. The second set of bit flip threshold values, as previously described, may be optimized for a second metric.

For each iteration of the second set of error correcting code operations, the processing device obtains the second bit flip threshold value of the plurality of second bit flip threshold values associated with a respective iteration of the second set of error correcting code operations. As previously described, each second bit flip threshold value of the plurality of second bit flip threshold values corresponds to an iterations of the second set of error correcting code operations. The processing device determines, for each bit of the encoded host data, whether a number of unsatisfied check nodes connected to a respective bit satisfies the second bit flip threshold value of the plurality of second bit flip threshold values associated with the respective iteration. As previously described, obtaining the number of unsatisfied check nodes includes identifying a number of non-zero values within a syndrome vector of the sense word. Responsive to determining that the number of unsatisfied check nodes connected to the respective bit satisfies the second bit flip threshold value of the plurality of second bit flip threshold values associated with the respective iteration, the processing device flips the respective bit of the encoded host data.

Responsive to determining that the second set of error correcting code operations has successfully corrected the one or more errors in the encoded host data, processing device returns host data. In particular, if any iterations of the second set of error correcting code operations have successfully corrected the one or more errors in the encoded host data, processing device returns host data.

Prior to proceeding to operations 430 to perform a third set of error correcting code operations on the encoded host data the processing device, for each bit of the encoded host data changed, returns a respective bit of the encoded host data back to an original value of the respective bit. As previously described, the processing device may undo any modification to the sense word done as a result of performing the second set of error correcting code operations.

At operation 430, responsive to determining that the second set of error correcting code operations has failed to correct the one or more errors in the encoded host data, the processing device performs, using a plurality of third bit flip threshold values, a third set of error correcting code operations on the encoded host data. The third set of bit flip threshold values, as previously described, may be optimized based on the first and/or the second set of bit flip threshold values. Accordingly, the third set of bit flip threshold values may be better in correcting the sense word containing errors than the second set of bit flip threshold values.

For each iteration of the third set of error correcting code operations, the processing device obtains the third bit flip threshold value of the plurality of third bit flip threshold values associated with a respective iteration of the third set of error correcting code operations. As previously described, each third bit flip threshold value of the plurality of third bit flip threshold values corresponds to an iterations of the third set of error correcting code operations. The processing device determines, for each bit of the encoded host data, whether a number of unsatisfied check nodes connected to a respective bit satisfies the third bit flip threshold value of the plurality of third bit flip threshold values associated with the respective iteration. As previously described, obtaining the number of unsatisfied check nodes includes identifying a number of non-zero values within a syndrome vector of the sense word. Responsive to determining that the number of unsatisfied check nodes connected to the respective bit satisfies the third bit flip threshold value of the plurality of third bit flip threshold values associated with the respective iteration, the processing device flips the respective bit of the encoded host data.

Responsive to determining that the third set of error correcting code operations has successfully corrected the one or more errors in the encoded host data, processing device returns host data. In particular, if any iterations of the third set of error correcting code operations have successfully corrected the one or more errors in the encoded host data, processing device returns host data. However, if the third set of error correcting code operations is unsuccess in correcting the one or more errors in the encoded host data, the processing device determines that the sense word is unable to be corrected.

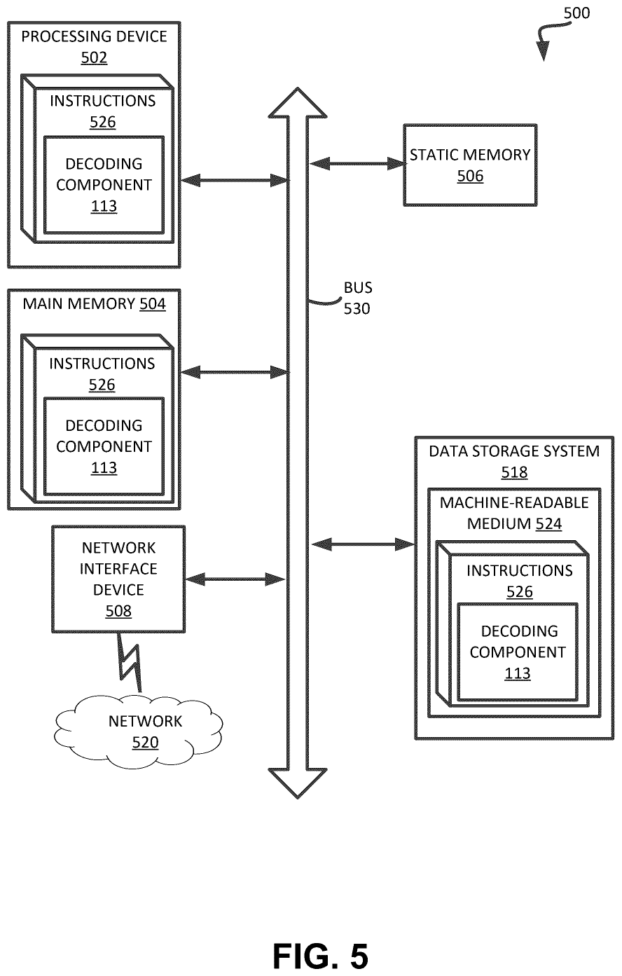

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to the decoding component 113 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1A.

In one embodiment, the instructions 526 include instructions to implement functionality corresponding to the decoding component 113 of FIG. 1A). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

What is claimed is:

1. A method comprising:
responsive to determining that an encoded host data read from a memory device contains one or more errors, performing, using a plurality of first bit flip threshold values, a first set of error correcting code operations on the encoded host data;
responsive to determining that the first set of error correcting code operations has failed to correct the one or more errors in the encoded host data, performing, using a plurality of second bit flip threshold values, a second set of error correcting code operations on the encoded host data; and
responsive to determining that the second set of error correcting code operations has failed to correct the one or more errors in the encoded host data, performing, using a plurality of third bit flip threshold values, a third set of error correcting code operations on the encoded host data.

2. The method of claim 1, wherein prior to performing the second set of error correcting code operations on the encoded host data comprises:
for each bit of the encoded host data changed, returning a respective bit of the encoded host data back to an original value of the respective bit.

3. The method of claim 1, wherein prior to performing the third set of error correcting code operations on the encoded host data comprises:
for each bit of the encoded host data, returning a respective bit of the encoded host data back to an original value of the respective bit.

4. The method of claim 1, further comprising:
responsive to determining that the first set of error correcting code operations, the second error correcting code operation, or the third set of error correcting code operations has successfully corrected the one or more errors in the encoded host data, returning host data.

5. The method of claim 1, wherein the plurality of third bit flip threshold values is optimized based on the plurality of second bit flip threshold values.

6. The method of claim 1, wherein performing the first set of error correcting code operations on the encoded host data comprises:
for each iteration of the first set of error correcting code operations associated with a bit of the encoded host data, obtaining a first bit flip threshold value of the plurality of first bit flip threshold values associated with a respective iteration of the first set of error correcting code operations;
determining, for each bit of the encoded host data, whether a number of unsatisfied check nodes connected to a respective bit satisfies the first bit flip threshold value of the plurality of first bit flip threshold values associated with the respective iteration; and
responsive to determining that the number of unsatisfied check nodes connected to the respective bit satisfies the first bit flip threshold value of the plurality of first bit flip threshold values associated with the respective iteration, flipping the respective bit of the encoded host data.

7. The method of claim 1, wherein performing the second set of error correcting code operations on the encoded host data comprises:
for each iteration of the second set of error correcting code operations associated with a bit of the encoded host data, obtaining a second bit flip threshold value of the plurality of second bit flip threshold values associated with a respective iteration of the second error correcting code operation;
determining, for each bit of the encoded host data, whether a number of unsatisfied check nodes connected to a respective bit satisfies the second bit flip threshold value of the plurality of second bit flip threshold values associated with the respective iteration; and
responsive to determining that the number of unsatisfied check nodes connected to the respective bit satisfies the second bit flip threshold value of the plurality of second bit flip threshold values associated with the respective iteration, flipping the respective bit of the encoded host data.

8. The method of claim 1, wherein performing the third set of error correcting code operations on the encoded host data comprises:
for each iteration of the third set of error correcting code operations associated with a bit of the encoded host data, obtaining a third bit flip threshold value of the plurality of third bit flip threshold values associated with a respective iteration of the third error correcting code operation;
determining, for each bit of the encoded host data, whether a number of unsatisfied check nodes connected to a respective bit satisfies the third bit flip threshold value of the plurality of third bit flip threshold values associated with the respective iteration; and
responsive to determining that the number of unsatisfied check nodes connected to the respective bit satisfies the third bit flip threshold value of the plurality of third bit flip threshold values associated with the respective iteration, flipping the respective bit of the encoded host data.

9. A system comprising:
a memory device; and
a processing device coupled to the memory device, the processing device to perform operations comprising:
responsive to determining that an encoded host data read from a memory device contains one or more errors, performing, using a plurality of first bit flip threshold values, a first set of error correcting code operations on the encoded host data;
responsive to determining that the first set of error correcting code operations has failed to correct the one or more errors in the encoded host data, performing, using a plurality of second bit flip threshold values, a second set of error correcting code operations on the encoded host data; and
responsive to determining that the second set of error correcting code operations has failed to correct the one or more errors in the encoded host data, performing, using a plurality of third bit flip threshold values, a third set of error correcting code operations on the encoded host data.

10. The system of claim 9, wherein performing, using the plurality of second bit flip threshold values, the second set of error correcting code operations on the encoded host data comprises:
for each bit of the encoded host data changed during the first set of error correcting code operations, returning a respective bit of the encoded host data back to an original value of the respective bit.

11. The system of claim 9, wherein performing, using the plurality of third bit flip threshold values, the third set of error correcting code operations on the encoded host data comprises:
for each bit of the encoded host data changed during the second error correcting code operation, returning a respective bit of the encoded host data back to an original value of the respective bit.

12. The system of claim 9, wherein the processing device is to perform operations further comprising:
responsive to determining that the first set of error correcting code operations, the second error correcting code operation, or the third set of error correcting code operations has successfully corrected the one or more errors in the encoded host data, returning host data.

13. The system of claim 9, wherein the plurality of third bit flip threshold values is optimized based on the plurality of second bit flip threshold values.

14. The system of claim 9, wherein performing the first set of error correcting code operations on the encoded host data comprises:
for each iteration of the first set of error correcting code operations associated with a bit of the encoded host data, obtaining a first bit flip threshold value of the plurality of first bit flip threshold values associated with a respective iteration of the first set of error correcting code operations;
determining, for each bit of the encoded host data, whether a number of unsatisfied check nodes connected to a respective bit satisfies the first bit flip threshold value of the plurality of first bit flip threshold values associated with the respective iteration; and
responsive to determining that the number of unsatisfied check nodes connected to the respective bit satisfies the first bit flip threshold value of the plurality of first bit flip threshold values associated with the respective iteration, flipping the respective bit of the encoded host data.

15. The system of claim 9, wherein performing the second set of error correcting code operations on the encoded host data comprises:
for each iteration of the second set of error correcting code operations associated with a bit of the encoded host data, obtaining a second bit flip threshold value of the plurality of second bit flip threshold values associated with a respective iteration of the second error correcting code operation;
determining, for each bit of the encoded host data, whether a number of unsatisfied check nodes connected to a respective bit satisfies the second bit flip threshold value of the plurality of second bit flip threshold values associated with the respective iteration; and
responsive to determining that the number of unsatisfied check nodes connected to the respective bit satisfies the second bit flip threshold value of the plurality of second bit flip threshold values associated with the respective iteration, flipping the respective bit of the encoded host data.

16. The system of claim 9, wherein performing the third set of error correcting code operations on the encoded host data comprises:
for each iteration of the third set of error correcting code operations associated with a bit of the encoded host data, obtaining a third bit flip threshold value of the plurality of third bit flip threshold values associated with a respective iteration of the third error correcting code operation;
determining, for each bit of the encoded host data, whether a number of unsatisfied check nodes connected to a respective bit satisfies the third bit flip threshold value of the plurality of third bit flip threshold values associated with the respective iteration; and
responsive to determining that the number of unsatisfied check nodes connected to the respective bit satisfies the third bit flip threshold value of the plurality of third bit flip threshold values associated with the respective iteration, flipping the respective bit of the encoded host data.

17. A non-transitory computer-readable storage medium comprising instructions that, when executed by a processing device, cause the processing device to perform operations comprising:
responsive to determining that an encoded host data read from a memory device contains one or more errors, performing, using a plurality of first bit flip threshold values, a first set of error correcting code operations on the encoded host data;
responsive to determining that the first set of error correcting code operations has failed to correct the one or more errors in the encoded host data, performing, using a plurality of second bit flip threshold values, a second set of error correcting code operations on the encoded host data; and
responsive to determining that the second set of error correcting code operations has failed to correct the one or more errors in the encoded host data, performing, using a plurality of third bit flip threshold values, a third set of error correcting code operations on the encoded host data.

18. The non-transitory computer-readable storage medium of claim 17, wherein performing, using the plurality of second bit flip threshold values, the second set of error correcting code operations on the encoded host data comprises:
for each bit of the encoded host data changed during the first set of error correcting code operations, returning a respective bit of the encoded host data back to an original value of the respective bit.

19. The non-transitory computer-readable storage medium of claim 17, wherein performing, using the plurality of third bit flip threshold values, the third set of error correcting code operations on the encoded host data comprises:
for each bit of the encoded host data changed during the second error correcting code operation, returning a respective bit of the encoded host data back to an original value of the respective bit.

20. The non-transitory computer-readable storage medium of claim 17, wherein the processing device is to perform operations further comprising:
responsive to determining that the first set of error correcting code operations, the second error correcting code operation, or the third set of error correcting code operations has successfully corrected the one or more errors in the encoded host data, returning host data.
